(19) United States
(12) Patent Application Publication
(10) Pub. No.: US 2026/0061568 A1
(43) Pub. Date: Mar. 5, 2026

(54) MULTIFUNCTIONAL GRIPPING PLIERS INTEGRATING A BIT DRIVER

(71) Applicant: Brennan Perot, Kingwood, TX (US)

(72) Inventor: Brennan Perot, Kingwood, TX (US)

(21) Appl. No.: 19/318,795

(22) Filed: Sep. 4, 2025

Related U.S. Application Data
(60) Provisional application No. 63/690,378, filed on Sep. 4, 2024.
(60) Provisional application No. 63/796,280, filed on Apr. 28, 2025.

(51) Int. Cl. B25B 7/22; B25B 7/04; B25B 7/10; B25B 7/14

(52) U.S. Cl. CPC B25B 7/22; B25B 7/04; B25B 7/10; B25B 7/14

(57) ABSTRACT

A multifunctional gripping pliers includes a first handle having a first extending section. The first extending section includes a first jaw having first gripping teeth, and a foldable tool hingedly connected to the first handle. The multifunctional gripping pliers further includes a second handle having a second extending section. The second extending section includes a second jaw having second gripping teeth, and a slot extending through the second extending section. The slot includes detents positioned at opposite sides of the slot. A pivot pin extends from the first extending section and is insertable into the slot. The first gripping teeth and the second gripping teeth face each other to form an opening for gripping an object therebetween, and the pivot pin locks in the detents to secure the first jaw and the second jaw in position. In some embodiments, the multifunctional gripping pliers incorporates a cam mechanism.

### CROSS-REFERENCE TO RELATED APPLICATIONS

The present application claims benefit of U.S. Provisional Application No. 63/796,280, filed Apr. 28, 2025; and U.S. Provisional Application No. 63/690,378, filed Sep. 4, 2024; all of which are incorporated herein in their entirety and referenced.

### BACKGROUND OF THE INVENTION

### Field of the Invention

The present invention relates to hand tools, and in particular, relates to multifunctional gripping pliers combining the functionalities of a gripping plier, a wire cutter, and a bit driver.

### Description of the Prior Art

Gripping pliers, often termed as “water pump pliers” are used in a wide range of industrial workpieces, including pipes, bolts and nuts. The gripping pliers are used for gripping/grabbing nuts, bolts, or any suitable material. The gripping pliers typically include a pair of handles, say a first handle and a second handle, each having a jaw/yaw. The first handle includes a pivot joint that is made to guide in an aperture in the second handle. The aperture encompasses detents that help to lock the position of the pivot joint in the aperture in order to adjust the spacing between the jaws of the first handle and the second handle. The spacing is adjusted depending on the dimensions of an object, say a bolt to be gripped.

Several attempts have been made in the past to provide gripping pliers of various configurations. One such example is disclosed in a U.S. Pat. No. 4,581,960, entitled “Water-pump pliers” (“the '960 Patent”). The '960 Patent discloses water-pump pliers having two plier handles which cross each other and are connected to each other by a pivot pin, whereby the handles form plier jaws above the region of crossing of the handles and grip sections below the region of crossing of the handles, and in which the first plier handle is adjustable in steps relative to the second plier handle to change the size of the plier jaws. The pivot pin is fitted and guided in a bore defined in the first plier handle and enters into form-locked engagement with the profiled flanks of a slot in the second plier handle, where the slot lies in the crossing region of the handles, and, in order to obtain a structural form which is simple to manufacture, favorable in operation and stable in use, the pivot pin is rendered incapable of turning with respect to the second plier handle.

Another example is disclosed in a U.S. Pat. No. 4,901,609, entitled “Adjustable pliers” (“the '609 Patent”). The '609 Patent discloses a pair of adjustable pliers consisting of first and second plier halves pivotally and slideably joined together by a nut and bolt-type combination fixed to the first plier half and extending through a slot in the second plier half. The second plier half includes a series of arcuate grooves cut into its interior surface, facing the first plier half. Correspondingly, the first plier half includes an arcuate raised portion that dimensionally matches and is pivotable within each of the arcuate slots. To adjust the jaw portions of the pliers, the arcuate raised portion is selectively engaged with one of the series of arcuate grooves. In order to engage the arcuate raised portion with a selected one of the arcuate grooves, the pliers are manipulated to a fully open, adjusting position where the arcuate raised portion disengages the arcuate grooves and is positioned substantially parallel to the slot. In this position, the plier halves are slideable to the desired position. A ball-type latch is secured to the first plier half and extends in a direction generally toward the second plier half. A plate is attached to the second plier half and includes a linear groove substantially parallel to the slot. When the plier halves are manipulated to the fully open, adjusting position, the ball-type latch engages the linear groove so as to urge the plier halves to remain in this fully open, adjusting position, thereby guiding the plier halves along a desired adjusting path.

Another example is disclosed in a U.S. Publication No. 20170028533, entitled “Adjustable pliers” (“the '533 Publication”). The '533 Publication discloses adjustable pliers for gripping and/or stabilizing nuts, bolts, pipes, rods, dowels, etc. The adjustable pliers include a pivot member in order to adjust the opening of the pliers'jaws, slide within a notched elongated slot though one arm of the pliers. The slot connects a series of notches, or apertures, along its axis of elongation. The pivot member is keyed to the other arm of the pliers. The arms are pivotable to cause either engagement of the locking faces with one of the apertures to determine the opening of the jaws or disengagement of the locking faces to allow movement of the pivot member along the slot to vary the opening of the jaws. An operator may choose to locate the pivot member in one of the notches by sliding it with the arm to which it is keyed along the slot.

Yet another example is disclosed in a U.S. Publication No. 20040221694, entitled “Pliers with movable joint” (“the '694 Publication”). The '694 Publication discloses a pair of pliers including a first body part having predetermined length, thickness, and shape; a second body part having length, thickness, and shape adapted to work with that of the first body part; and a joint pivotally connecting the first and the second body part together at a predetermined position. The joint is movable within a defined range to enable quick adjustment of jaw opening of the pliers, and is locked in place once it is moved to a desired position.

Although the above discussed disclosures are useful, they have few problems. For example, existing pliers are limited for gripping and/or stabilizing nuts, bolts, pipes, etc. The pliers cannot be used for driving smaller screws. As a result, an operator has to carry multiple tools for gripping the objects and to drive smaller screws. In addition, traditional plier multi tools often have a very limited jaw capacity making them inadequate for industrial applications such as plumbing, Heating, Ventilation, and Air Conditioning (HVAC), oil/gas, and industrial maintenance. There are several needle nose plier/screwdriver multitools existing in the market. However, there are no pliers integrating a water pump pliers and a screwdriver.

Therefore, there is a need in the art to provide multifunctional gripping pliers combining the functionalities of a gripping plier, a wire cutter, and a bit driver.

### SUMMARY OF THE INVENTION

It is an object of the present invention to provide multifunctional gripping pliers that integrate the functionalities of water pump pliers, a wire cutter, and a bit driver in a single device.

It is another object of the present invention to provide gripping pliers integrating a foldable bit driver capable of receiving various ¼″ bits and that allows the gripping pliers to be used as a screwdriver.

It is another object of the present invention to provide gripping pliers having a cutting portion at the back of the jaws facilitating wire cutting and stripping.

In order to achieve one or more objects, the present invention provides multifunctional gripping pliers combining the functionalities of a gripping plier, a wire cutter, and a bit driver. The gripping pliers include a first handle having a first jaw. The first handle encompasses a pivot pin. Further, the gripping pliers include a second handle having a second jaw. The second handle encompasses a slot having detents and retaining regions. Each of the first jaw and the second jaw includes gripping teeth. The pivot pin inserts in the slot such that the gripping teeth face each other and form an opening for gripping an object such as a pipe, bolt, etc. therebetween.

Further, the first handle integrates a foldable bit driver (or drive member or tool) at its distal end. The bit driver is configured to receive various ¼″ bits allowing the gripping pliers to be used as a screwdriver. The bit driver integrates a magnetic member allowing the bit driver to fold over the first handle with a push. The foldable bit driver allows the gripping pliers to be used as a traditional foldout pocket knife whereby the bit driver is locked into place when folded out using a flat piece of spring steel.

Furthermore, the first handle integrates a foldable knife member at its distal end. The knife member is positioned adjacent to the bit driver. The knife member integrates a magnetic member allowing the knife member to fold over the first handle with a push. The foldable knife member allows the gripping pliers to be used as a traditional knife whereby the knife member is locked into place when folded out using a flat piece of spring steel. The foldable bit driver and the knife member make the gripping pliers appear like a Swiss army knife.

The jaws include cutting portions at the back and adjacent to the gripping teeth allowing the gripping pliers to be used as wire cutters to cut/strip wire.

In one aspect, the gripping pliers incorporate a cam mechanism to adjust the position of the jaws. The second handle includes a fixed jaw, and a movable jaw is removably attached to the second handle. The cam mechanism includes a cam lock positioned at the first handle, and a cam groove provided at the movable jaw. The cam lock engages the cam groove to lock the movable jaw relative to the fixed jaw for gripping flat-sided objects such as nuts and hex bolts.

In another aspect, the gripping pliers may include one or more holes positioned at various locations on the handles and jaws for wire drawing and bending operations. The holes may be positioned at the distal end of the first handle, the distal end of the second handle, or at the top of the second jaw. The holes may be configured to accommodate various wire gauges and facilitate bending operations in electrical and plumbing applications.

In yet another aspect, the first handle may integrate a hammer region at its outer side. The hammer region may be positioned at the back of the first handle to provide impact capability for various applications. The hammer region may present a textured or flat striking surface that allows the gripping pliers to be used for light hammering operations without requiring a separate hammer tool.

In a further aspect, the gripping pliers may incorporate flat end sections on the jaws to enhance gripping capability for rounded or irregular shaped objects. The first jaw may include a first end section having a flat configuration, and the second jaw may include a second end section having a flat configuration. The first end section and second end section may be positioned to face each other in parallel alignment, allowing the jaws to provide improved grip on nuts, bolts, and other fasteners while maintaining parallel jaw action during opening and closing operations.

In one advantageous feature of the present invention, the gripping pliers integrates the functionalities of water pump pliers, a wire cutter, and a bit driver in a single device. This saves space in toolkits and reduces the time spent switching between different tools in various industrial applications, including plumbing, Heating, Ventilation, and Air Conditioning (HVAC), oil/gas, and general maintenance.

In another advantageous feature of the present invention, the self-locking jaws provide a large jaw capacity of up to 1.25″, making the gripping pliers suitable various industrial applications.

In another advantageous feature of the present invention, the gripping pliers have hardened cutting edges in the back of jaws that allow for wire cutting and stripping. This eliminates the need for separate wire cutters.

In yet another advantageous feature of the present invention, the gripping pliers presents a foldable bit driver that is capable of accepting various ¼″ bits. Bits of any shape can be used for driving screws similar to a screwdriver. The bit driver folds over and does not come in the way of using the gripping pliers as traditional gripping pliers.

In a further advantageous feature of the present invention, the gripping pliers incorporates a hammer region integrated at the outer side of the first handle. The hammer region provides impact capability for various applications without requiring a separate hammer tool.

In another advantageous feature of the present invention, the gripping pliers includes one or more strategically positioned holes for wire drawing and bending operations, enhancing its utility in electrical and plumbing applications.

In yet another advantageous feature of the present invention, the gripping pliers incorporates a cam mechanism with a cam lock and cam groove that allows for precise adjustment and locking of the movable jaw relative to the fixed jaw, particularly beneficial when gripping flat-sided objects such as nuts and hex bolts.

In another advantageous feature of the present invention, the gripping pliers incorporates flat end sections on the jaws that maintain parallel alignment during opening and closing operations, providing improved grip on rounded or irregular shaped objects while ensuring consistent pressure distribution across the gripping surface.

These and other objects of the present invention will be apparent from review of the following specification and the accompanying drawings.

### BRIEF DESCRIPTION OF THE DRAWINGS

FIG. 1 is an environment in which gripping pliers implement, in accordance with one exemplary embodiment of the present invention.

FIG. 2 shows a perspective view of the gripping pliers in a closed configuration, in accordance with one embodiment of the present invention.

FIG. 3 is a side view of the gripping pliers in which a bit driver extends from a first handle, in accordance with one embodiment of the present invention.

FIG. 4 and FIG. 5 show widening of gap between jaws for gripping objects therebetween, in accordance with one embodiment of the present invention.

FIG. 6 is a side view of the gripping pliers in which a knife member extends adjacent to the bit driver and from the first handle, in accordance with one embodiment of the present invention.

FIG. 7 is a side view of the first handle showing the bit driver and the knife member positioned side-by-side, in accordance with one embodiment of the present invention.

FIG. 8 is a front view of a gripping pliers, in accordance with another exemplary embodiment of the present invention.

FIG. 9 is a front view of a gripping pliers, in accordance with another exemplary embodiment of the present invention.

FIG. 10 shows widening of gap between jaws for gripping objects therebetween, in accordance with another exemplary embodiment of the present invention.

FIG. 11 is a front view of a gripping pliers, in accordance with another exemplary embodiment of the present invention.

FIG. 12 is a front view of a gripping pliers, in accordance with yet another exemplary embodiment of the present invention.

FIG. 13 is a front view of a gripping pliers, in accordance with yet another exemplary embodiment of the present invention.

FIG. 14 is a front view of a gripping pliers, in accordance with yet another exemplary embodiment of the present invention.

FIG. 15 is a front view of gripping pliers, in accordance with another embodiment of the present invention.

FIG. 16 and FIG. 17 show a first handle having a hammer region, in accordance with various embodiments of the present invention.

FIG. 18 is a side view of a second handle showing a second hole positioned at its distal end for wire bending operations, in accordance with one embodiment of the present invention.

FIG. 19A and FIG. 19B show a front view, and a rear view, respectively, of gripping pliers, in accordance with another exemplary embodiment of the present invention.

FIG. 20 is an expanded view of jaw, in accordance with one embodiment of the present invention.

FIG. 21 shows the jaw in an open configuration, in accordance with one embodiment of the present invention.

FIG. 22 shows the jaw in a closed configuration, in accordance with one embodiment of the present invention.

### DETAILED DESCRIPTION OF THE PREFERRED EMBODIMENT

The detailed description set forth below in connection with the appended drawings is intended as a description of exemplary embodiments in which the presently disclosed invention may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed gripping pliers. However, it will be apparent to those skilled in the art that the presently disclosed invention may be practiced without these specific details. In some instances, well-known structures and devices are shown in functional or conceptual diagram form in order to avoid obscuring the concepts of the presently disclosed gripping pliers.

In the present specification, an embodiment showing a singular component should not be considered limiting. Rather, the invention preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present invention encompasses present and future known equivalents to the known components referred to herein by way of illustration.

Although the present invention describes gripping pliers, it is to be further understood that numerous changes may arise in the details of the embodiments of the gripping pliers. It is contemplated that all such changes and additional embodiments are within the spirit and true scope of this invention.

The following detailed description is merely exemplary in nature and is not intended to limit the described embodiments or the application and uses of the described embodiments. As used herein, the word “exemplary” or “illustrative” means “serving as an example, instance, or illustration. ” Any implementation described herein as “exemplary” or “illustrative” is not necessarily to be construed as preferred or advantageous over other implementations. All of the implementations described below are exemplary implementations provided to enable persons skilled in the art to make or use the embodiments of the invention and are not intended to limit the scope of the invention.

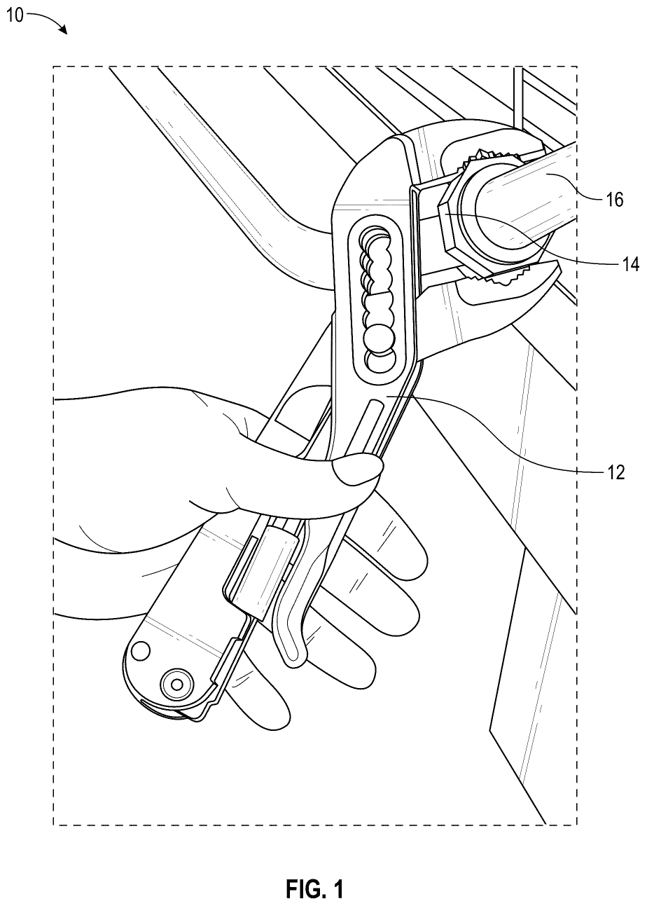

Various features and embodiments of multifunctional gripping pliers are explained in conjunction with the description of FIGS. 1-22.

FIG. 1 shows an environment 10 in which multifunctional gripping pliers or simply gripping pliers 12 implements, in accordance with one exemplary embodiment of the present invention. Gripping pliers 12 is also referred to as water-pump pliers 12. Gripping pliers 12 grip objects 16, and also tighten screws and cut wires. Examples of objects 16 include nuts, bolts, pipes, rods, dowels, etc. FIG. 1 shows bolt 16 around a pipe gripped by gripping pliers 12.

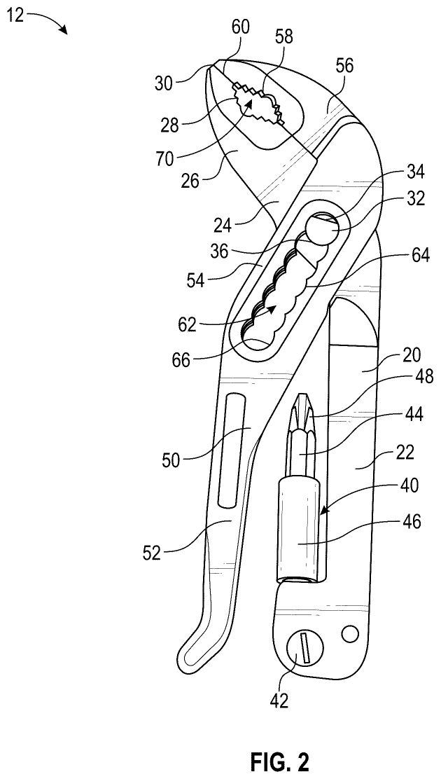

FIG. 2 shows a side view of gripping pliers 12 in a closed configuration, in accordance with one embodiment of the present invention. Gripping pliers 12 includes a pair of handles, say a first handle 20 and a second handle 50. In one implementation, first handle 20 indicates a bottom handle and second handle 50 indicates a top handle, or vice versa. As can be seen from FIG. 2, first handle 20 positions underneath second handle 50. First handle 20 presents a first gripping portion 22. First gripping portion 22 includes a non-slippery surface or receives a grip for firm grip. First handle 20 includes a first extending section 24 extending from first handle 20. As can be seen, first extending section 24 extends at an angle from first handle 20. In one example, first handle 20 and first extending section 24 come as a single component. Here, first extending section 24 extends between 20-45-degree angle from first handle 20. Further, first extending section 24 encompasses a first jaw 26. First jaw 26 presents a first gripping teeth 28 and a fine teeth 30. Each of first gripping teeth 28 and fine teeth 30 indicates a gripping surface. As can be seen, first gripping teeth 28 have teeth at about 90-degree angle, and fine teeth 30 presents a flat surface. In the present embodiment, first handle 20 includes a pivot pin 32. Pivot pin 32 indicates a ridge or extending section extending from the surface of first extending section 24 facing second handle 22. In one example, pivot pin 32 includes a flat section or cutout section 34 and an arcuate section 36. Cutout section 34 indicates a straight section and arcuate section 36 indicates a curved section extending from cutout section 34.

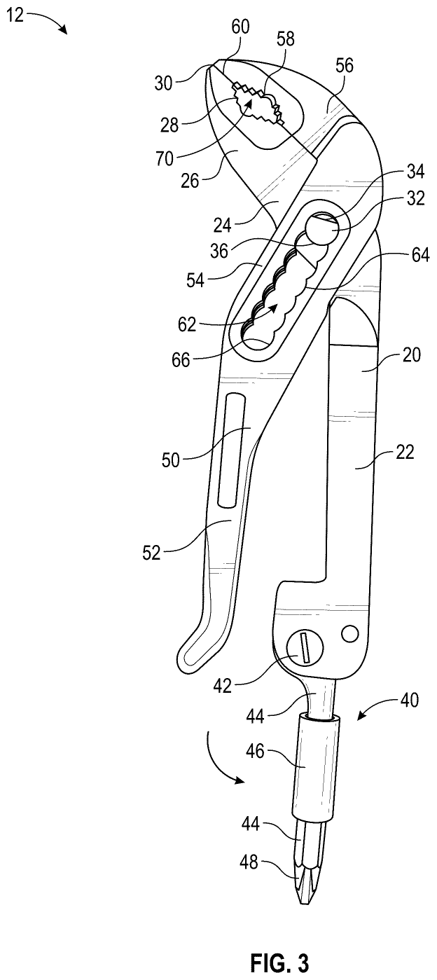

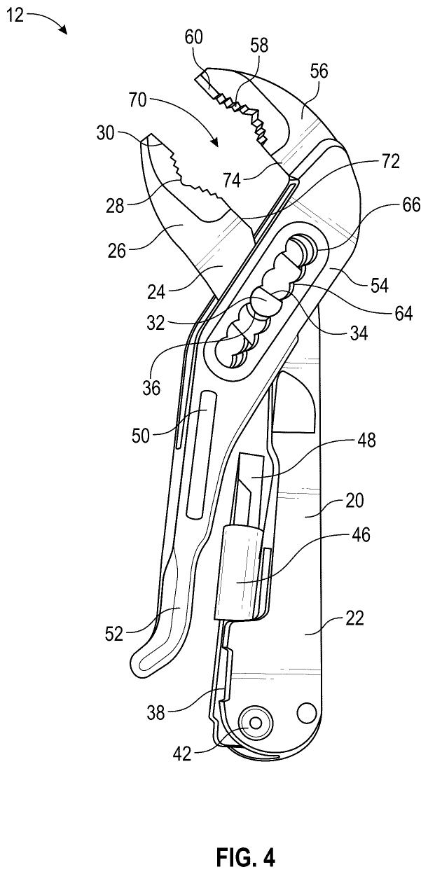

Gripping pliers 12 includes a driver receiving section 38 at the bottom i.e., at the end of first gripping portion 22. Driver receiving section 38 defines an area configured to receive a driver member or tool 40 in its closed configuration, as shown in FIG. 4, for example. Driver member 40 indicates a bit driver. In one example, drive member 40 removably connects to gripping pliers 12 via a connecting member 42, such as a fastener. Here, drive member 40 hingedly connects to gripping pliers 12 such that drive member 40 folds and sits adjacent to first handle 20, as shown in FIG. 2. Further, drive member 40 extends from first handle 20 in an open configuration or engaged configuration, as shown in FIG. 3, for example. Drive member 40 includes a shank 44, a body 46 and a tip 48 at its distal end. Tip 48 comes in a variety of shapes and sizes depending on the need. In one example, tip 48 comes in a sharp angled tip. In another example, tip 48 comes in the shape of a flathead, cross slot (Phillips), pozidriv, torx, hexagon, etc. corresponding to the type of the screws that need to be driven (removed or tightened).

Still referring to FIG. 2 and FIG. 3, gripping pliers 12 includes a second handle 50. Second handle 50 presents a second gripping portion 52. Second handle 50 includes a second extending section 54 extending from second handle 50. As can be seen, second extending section 54 extends at an angle from second handle 50. In one example, second extending section 54 extends between 20-45-degree angle from second handle 50. Further, second extending section 54 encompasses a second jaw 56. Second jaw 56 encompasses a second gripping teeth 58 and a fine teeth 60. Each of second gripping teeth 58 and fine teeth 60 indicates a gripping surface. As can be seen, second gripping teeth 58 have teeth positioned at about 90-degree angle, and fine teeth 60 presents a flat surface.

Further, second extending section 54 includes a slot or aperture 62. Slot 62 has an elongated configuration and includes detents 64. Detents 64 indicate a series of curved steps or arcuate surfaces 64 positioned at opposite sides of slot 62 that allow pivot pin 32 to guide along and lock at different positions. Here, detents 62 are positioned by pairs of opposite side curved steps or arcuate surfaces 64 facing each other. In one example, slot 62 includes retaining regions 66 at distal ends for inserting pivot pin 32. Slot 62 may have a length ranging from 25-40 mm with detent spacing of approximately 3-5 mm intervals, allowing for jaw opening adjustments in increments corresponding to common fastener sizes. In some embodiments, pivot pin 32 may be manufactured from hardened steel with a Rockwell hardness of HRC 45-55 to provide durability under repeated adjustment cycles. Cutout section 34 ensures proper engagement with detents 64, while arcuate section 36 having a radius of curvature between 3-8 mm to facilitate smooth sliding motion within slot 62.

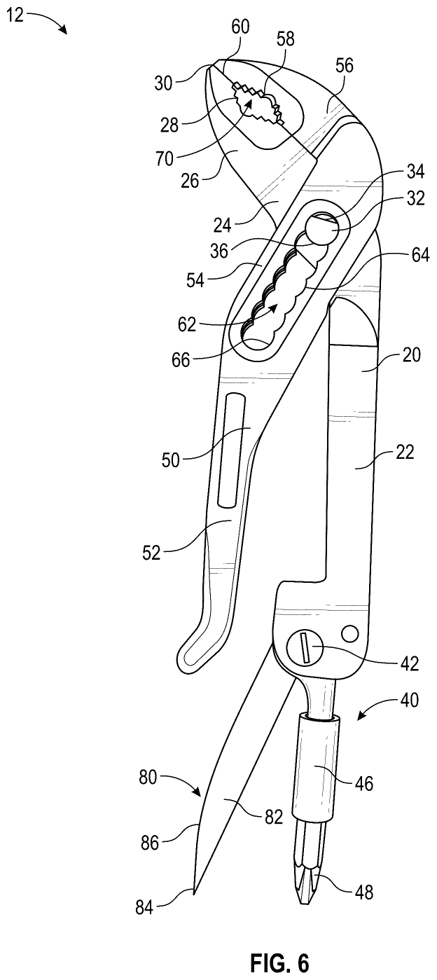

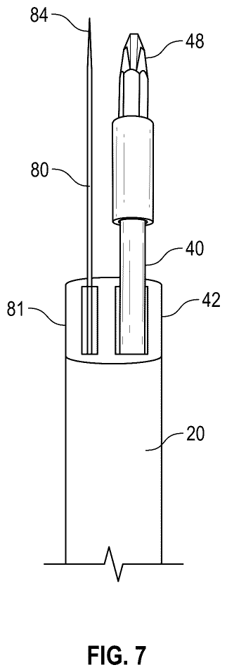

In one alternate embodiment, gripping pliers 12 includes a knife member or knife blade 80, as shown in FIG. 6. Knife member 80 positions in driver receiving section 38 adjacent to driver member 40 in its closed configuration. FIG. 7 shows the feature of driver member 40 and knife member 80 in open configuration. Knife member 80 removably connects to gripping pliers 12 via a fastener 81, such as a fastener. Here, knife member 80 hingedly connects to gripping pliers 12 such that knife member 80 folds and sits adjacent to drive member 40 within first handle 20. Knife member 80 extends from first handle 20 in an open configuration or engaged configuration, as shown in FIG. 6, for example. Knife member 80 includes a body 82, having a tip 84 and a cutting edge 86. Cutting edge 86 indicates the side of knife member 90 grounded to a very thin, very sharp point for cutting or slicing objects.

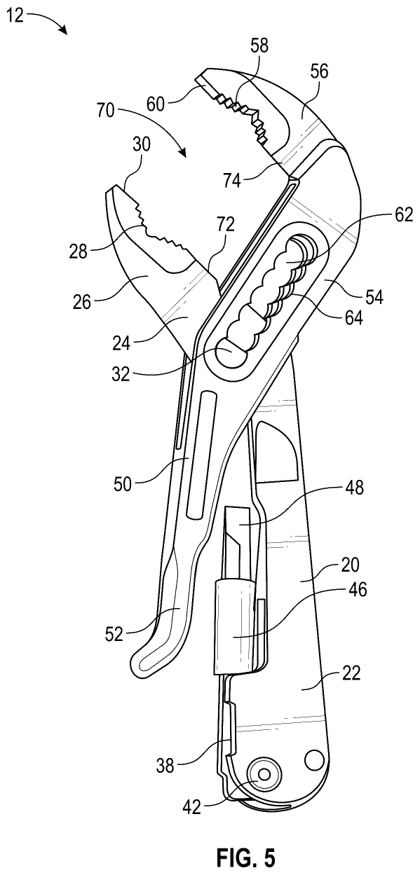

In order to connect first handle 20 and second handle 50, pivot pin 32 is inserted in slot 62 as shown in FIG. 2. First jaw 26 and second jaw 56 are angled relative to first handle 20 and second handle 50, such that first gripping teeth 28 and second gripping teeth 58 face each other in parallel when gripping pliers 12 is in closed configuration. The space or opening 70 formed between first gripping teeth 28 and second gripping teeth 58 permits holding/gripping of object 14 such as pipe, bolt, etc. FIG. 4 shows pivot pin 32 at substantially half the length of slot 62. Here, opening 70 widens between first gripping teeth 28 and second gripping teeth 58 for gripping object 14. Further, FIG. 5 shows pivot pin 32 substantially at the bottom of slot 62. Here, opening 70 widens further increasing the gap between first gripping teeth 28 and second gripping teeth 58 for gripping larger objects 14. Pivot pin 32 locks in detents 64 allowing first jaw 26 and second jaw 56 to be locked in a position for secure gripping of object 14 such as nut, bolt and other miscellaneous materials. A person skilled in the art understands that FIG. 4 and FIG. 5 show the size of jaws 26, 56 that can be adjusted in multiple sections/positions at detents 64 depending on the need. The presently disclosed gripping pliers 12 presents a large jaw capacity and ability to grip nuts/bolts/pipe of up to 1.25″ sets when compared to existing plier/screwdriver multitools.

The self-locking serrated jaws 26, 56 securely grip pipe, nuts/bolts, and other objects 14. The self-locking serrated jaws 26, 56 include right-angled gripping teeth 28, 58 that grip object 14 in all directions for a stable clamping ability and a tight bite. Since gripping pliers 12 is capable of self-locking, the harder bottom jaw handle i.e., first handle 20 is pushed, the harder jaws 26, 56 bite. Unlike traditional pliers, a user does not have to increasingly squeeze the top and bottom handles 50, 20 to achieve a better grip. A person skilled in the art understands that the self-locking action is achieved through the geometric relationship between pivot pin 32 and detents 64, where the contact angle creates a mechanical advantage, allowing applied grip force to be multiplied at the jaw interface. The detent geometry may incorporate a lead-in angle for easy engagement and a locking angle of to prevent inadvertent release.

In one embodiment, first jaw 26 includes a first cutting portion 72, and second jaw 56 includes a second cutting portion 74. Each of first cutting portion 72 and second cutting portion 74 presents a hardened/sharpened edge in the back of first jaw 26 and second jaw 56, respectively allowing gripping pliers 12 to be used to cut and strip wire. Here, the integrated wire cutting feature in the rear of jaws 26, 56 allows for gripping pliers 12 to be used as a pair of dikes (wire cutters). The dikes feature can also be used to strip electrical wire.

As presented above, first handle 20 includes a hingedly connecting drive member 40 and knife member 80. In closed configuration, drive member 40 and knife member 80 fold over and integrate into handles 20, 50. In one example, drive member 40 and knife member 80 integrate magnetic members allowing drive member 40 and knife member 80 to fold over first handle 20 with a push. The magnetic members may comprise neodymium magnets with a pull force of 5-15 pounds, positioned within recessed cavities in first handle 20 to prevent interference with normal plier operation. The magnetic attraction may be sufficient to retain the folded components during transport while allowing easy deployment with minimal force. Drive member 40 is extended to be used as a screwdriver. In one example, drive member 40 allows inserting any ¼″ bit, such as Philips bits, regular bits, hex bits, etc. The foldable drive member 40 allows gripping pliers 12 to be used as a traditional foldout pocket knife whereby the bit driver is locked into place when folded out using a flat piece of spring steel. Similarly, knife member 80 is extended to be used as a knife for cutting or slicing objects. The foldable drive member 40 and knife member 80 allow gripping pliers 12 to be used as a Swiss army knife.

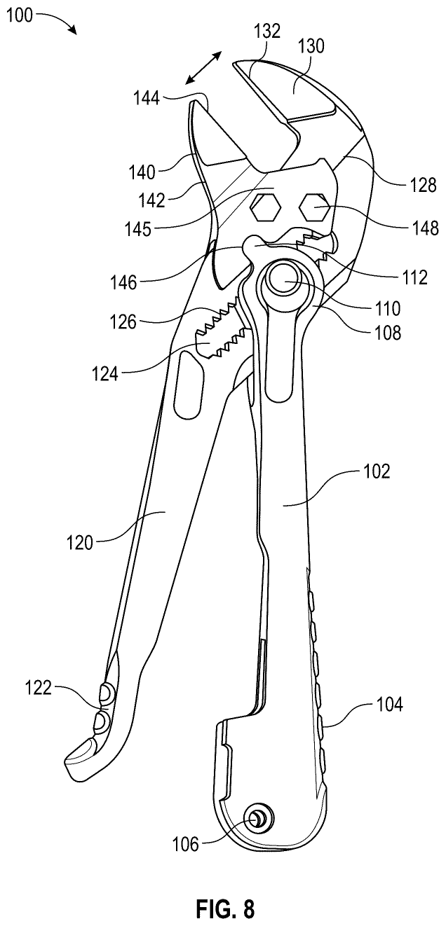

FIG. 8 shows a front view of gripping pliers 100, in accordance with another embodiment of the present invention. Gripping pliers 100 integrates a cam mechanism for jaw adjustment to grip objects. Gripping pliers 100 includes a pair of handles, a first handle 102 and a second handle 120. First handle 102 includes a first gripping portion 104. First gripping portion 104 has a non-slippery surface or ridged surface to facilitate gripping of first handle 102. First handle 102 includes a drive slot 106. Drive slot 106 is positioned at the distal end of first handle 102 and receives a drive member (not shown) and/or knife member (not shown), as shown in FIG. 2 and/or FIG. 6.

Further, first handle 102 includes a connecting portion 108. Connecting portion 108 is positioned at the opposite end of slot 106. Connecting portion 108 includes a pivot pin 110. Further, connecting portion 108 includes a cam lock 112. Cam lock 112 extends from the surface of connecting portion 108 and facilitates locking of first handle 102 relative to second handle 120.

Second handle 120 presents a second gripping portion 122. Second handle 120 includes an extending section 128. As can be seen, extending section 128 extends at an angle from second handle 120. In one example, extending section 128 extends at an angle of 20-45 degrees from second handle 120. Extending section 128 includes a slot or aperture 124. Slot 124 has an elongated configuration and includes detents 126. Detents 126 indicate a series of curved or arcuate surfaces positioned at opposite sides of slot 124 that allow pivot pin 110 to guide along and lock at different positions. Here, detents 126 are positioned by pairs of opposite side curved steps or arcuate surfaces. Further, extending section 128 includes a first jaw 130. First jaw 130 encompasses a first flat section 132. First flat section 132 grips flat-sided objects such as nuts and hex bolts.

Further, gripping pliers 100 includes a second jaw 140. Second jaw 140 removably connects to first handle 102 and interfaces with first flat section 132. Second jaw 140 includes a curved section 142 and a second flat section 144. Second flat section 144 interfaces with first flat section 132 and grips flat-sided objects such as nuts and hex bolts. In some implementations, second jaw 140 includes a connecting section 145 that goes over extending section 128 and enables second jaw 140 to connect to second handle 120. Connecting section 145 includes a cam groove 146. Cam groove 146 is configured to operatively receive cam lock 112 and adjust second jaw 140 to increase or decrease the distance between first flat section 132 and second flat section 144. In one example, cam lock 112 may have a cam profile with a rise angle of 15-30 degrees and a dwell period of 45-60 degrees of rotation to provide mechanical advantage during jaw adjustment. The cam groove 146 may have a depth of 1-3 mm with radiused entry and exit points to reduce wear during engagement and disengagement. It should be understood that first jaw 130 acts as a fixed jaw and second jaw 140 acts as a movable jaw by the operation of pivot pin 110 in slot 124 and locking of cam lock 112 at cam groove 146. In some cases, connecting section 145 has grooves 148 positioned in hexagonal or any other configuration. The hexagonal grooves 148 indicate ¼″ hex drive for removing or tightening hex nuts, for example.

The integration of pivot pin 110 within slot 124, and cam mechanism formed by cam lock 112 and cam groove 146, allows adjustment of jaw opening between first flat section 132 and second flat section 144 and locking of second jaw 140 relative to first jaw 130.

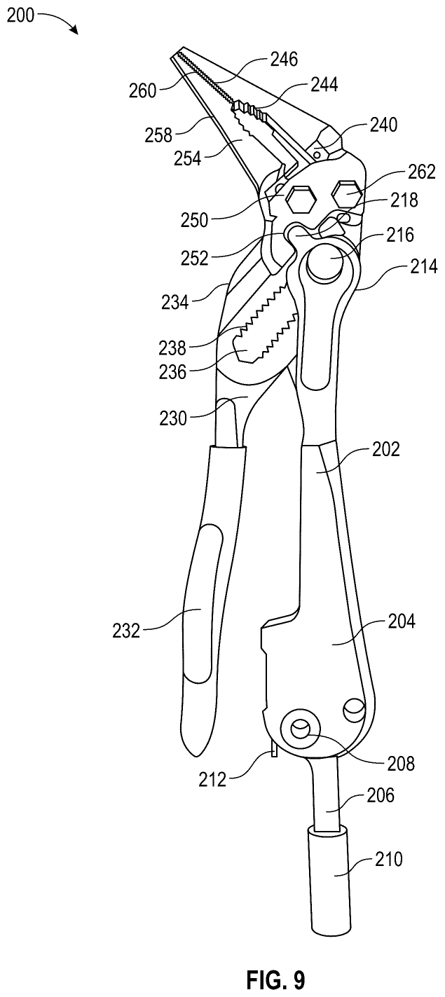

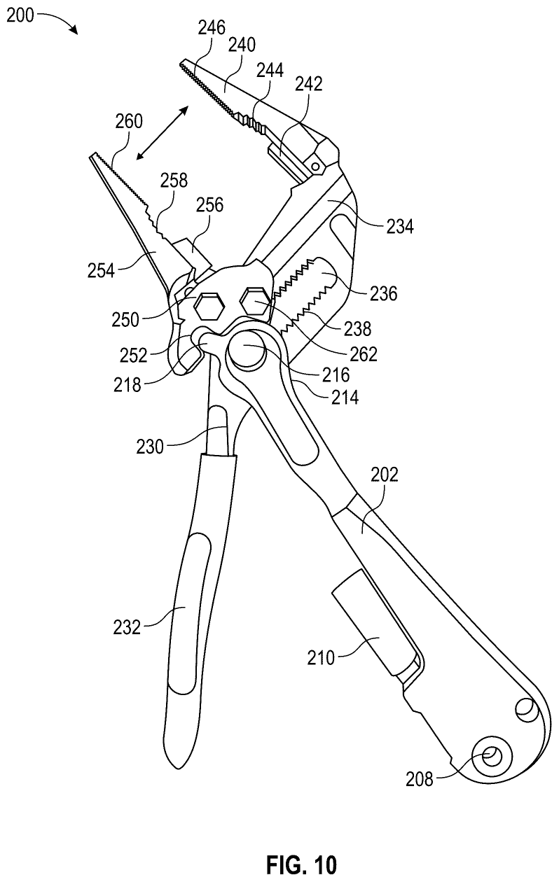

FIG. 9 shows a front view of gripping pliers 200, in accordance with another embodiment of the present invention. Gripping pliers 200 integrates a cam mechanism for jaw adjustment to grip objects. Gripping pliers 200 includes a pair of handles i.e., a first handle 202 and a second handle 230. First handle 202 includes a first gripping portion 204. First gripping portion 204 has a non-slippery surface or ridged surface to facilitate gripping of first handle 202. First handle 202 includes an extending rod 206 that swivels and folds into first handle 202, as shown in FIG. 10. Extending rod 206 connects via a connector 208. Connector 208 is positioned at the distal end of first handle 202 and receives extending rod 206. In some embodiments, extending rod 206 includes a drive member 210. Drive member 210 may be replaced by different tools such as saws, files, etc. Further, first handle 202 encompasses a tab member 212 that functions as a bottle opener.

Further, first handle 202 includes a connecting portion 214. Connecting portion 214 is positioned at the opposite end of connector 208. Connecting portion 214 includes a pivot pin 216. Further, connecting portion 214 includes a cam lock 218. Cam lock 218 extends from the surface of connecting portion 214 and facilitates locking of first handle 202 relative to second handle 230.

Second handle 230 includes a second gripping portion 232. Second handle 230 includes an extending section 234. As can be seen, extending section 234 extends at an angle from second handle 230. In one example, extending section 234 extends at an angle of 20-45 degrees from second handle 230. Extending section 234 includes a slot or aperture 236. Slot 236 has an elongated configuration and includes detents 238. Detents 238 indicate a series of curved or arcuate surfaces positioned at opposite sides of slot 236 that allow pivot pin 216 to guide along and lock at different positions. Here, detents 238 are positioned by pairs of opposite side curved steps or arcuate surfaces. Further, extending section 234 includes a first jaw 240. First jaw 240 extends perpendicularly from extending section 234. First jaw 240 encompasses a first flat section 242. First flat section 242 is used to cut wire. First jaw 240 includes first teeth 244 and second teeth 246. First teeth 244 are positioned adjacent to first flat section 242, and second teeth 246 are positioned adjacent to first teeth 244.

Further, gripping pliers 200 includes a connecting section 250. Connecting section 250 removably connects to first handle 202, and includes a cam groove 252. Connecting section 250 includes a second jaw 254. Second jaw 254 includes a second section 256. Second section 256 is sharp and used to cut wires with first flat section 242. Further, second jaw 254 includes third teeth 258 and fourth teeth 260. Third teeth 258 and fourth teeth 260 interface first teeth 244 and second teeth 246, respectively, to hold objects, as explained above. In some cases, connecting section 250 has grooves 262 positioned in hexagonal or any other configuration. FIG. 10 shows pivot pin 216 substantially at the bottom of slot 236 to widen the gap between first jaw 240 and second jaw 254.

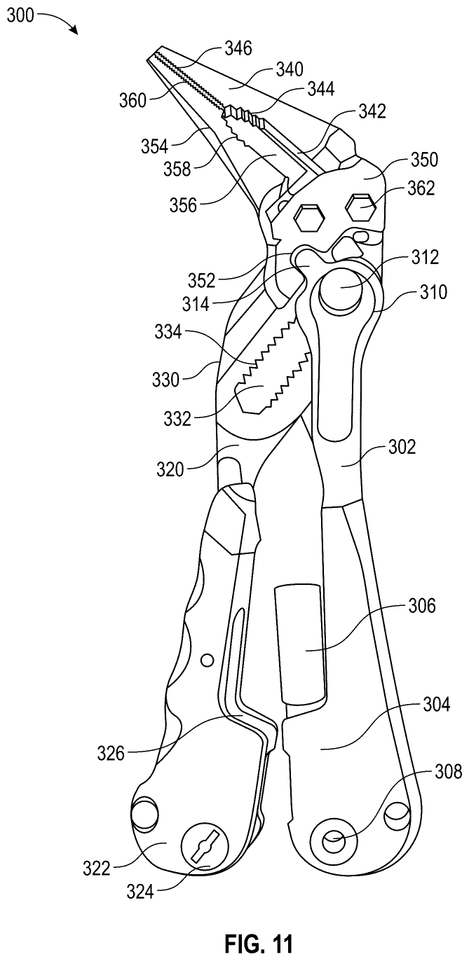

FIG. 11 shows a front view of gripping pliers 300, in accordance with another embodiment of the present invention. Gripping pliers 300 integrates a cam mechanism for jaw adjustment to grip objects. Gripping pliers 300 includes a pair of handles i.e., a first handle 302 and a second handle 320. First handle 302 includes a first gripping portion 304. First gripping portion 304 has a non-slippery surface or ridged surface to facilitate gripping of first handle 302. First handle 302 includes a drive member 306 connected by a first connecting member 308. Drive member 306 may include knife member (not shown), as shown in FIG. 2 and/or FIG. 6. Further, first handle 302 includes a connecting portion 310. Connecting portion 310 is positioned at the opposite end of first gripping portion 304. Connecting portion 310 includes a pivot pin 312. Further, connecting portion 310 includes a cam lock 314. Cam lock 314 extends from the surface of connecting portion 310 and facilitates locking of first handle 302 relative to second handle 320.

Second handle 320 presents a second gripping portion 322. Second gripping portion 322 has a non-slippery surface or ridged surface to facilitate gripping of second handle 320. Second gripping portion 322 includes a driver receiving section 326 configured to receive another drive member (not shown). Here, the drive member is connected by a screw 324. The presently disclosed embodiment is shown to illustrate two drive members that can be connected to front and rear handles (first and second handles).

Further, second handle 320 includes an extending section 330 that extends at an angle from second handle 320. In one example, extending section 330 extends at an angle of 20-45 degrees from second handle 320. Extending section 330 includes a slot or aperture 332. Slot 332 has an elongated configuration and includes detents 334. Detents 334 indicate a series of curved or arcuate surfaces positioned at opposite sides of slot 332 that allow pivot pin 312 to guide along and lock at different positions. Here, detents 334 are positioned by pairs of opposite side curved steps or arcuate surfaces. Further, extending section 330 includes a first jaw 340. First jaw 340 extends perpendicularly from extending section 330. First jaw 340 encompasses a first flat section 342 used to cut wire. First jaw 340 includes first teeth 344 and second teeth 346. First teeth 344 are positioned adjacent to first flat section 342, and second teeth 346 are positioned adjacent to first teeth 344.

Further, gripping pliers 300 includes a connecting section 350. Connecting section 350 removably connects to first handle 302, and includes a cam groove 352. Connecting section 350 includes a second jaw 354. Second jaw 354 includes a second section 356. Second section 356 is sharp and used to cut wires with first flat section 342. Further, second jaw 354 includes third teeth 358 and fourth teeth 360. Third teeth 358 and fourth teeth 360 interface first teeth 344 and second teeth 346, respectively, to hold objects, as explained above. Gripping pliers 300 operates similar to gripping pliers 200. In some cases, connecting section 350 has grooves 362 positioned in hexagonal or any other configuration.

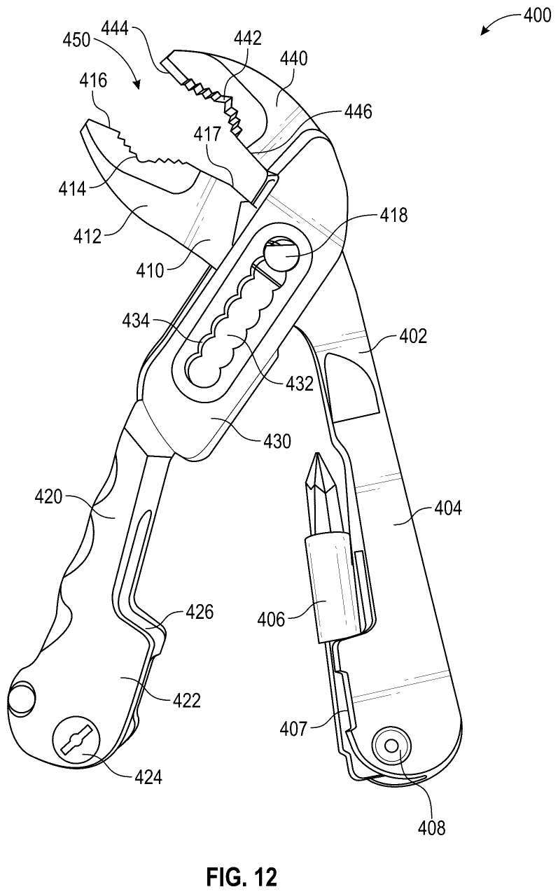

FIG. 12 shows a front view of gripping pliers 400, in accordance with another embodiment of the present invention. Gripping pliers 400 includes a pair of handles i.e., a first handle 402 and a second handle 420. First handle 402 includes first gripping portion 404. First gripping portion 404 has a non-slippery surface or ridged surface to facilitate gripping of first handle 402. First handle 402 includes a driver receiving section 407 at the bottom i.e., at the end of first gripping portion 404. Driver receiving section 407 defines an area configured to receive a driver member 406 in its closed configuration. Driver member 406 connects to first handle 402 via a first connecting member 408. Here, drive member 406 hingedly connects to gripping pliers 400 such that drive member 406 folds and sits adjacent to first handle 402. Further, drive member 406 extends from first handle 402 in an open configuration or engaged configuration, as explained above.

First handle 402 includes a first extending section 410. First extending section 410 extends at an angle of 20-45-degrees from first handle 402. In one example, first handle 402 and first extending section 410 come as a single component. Further, first extending section 410 encompasses a first jaw 412. First jaw 412 presents a first gripping teeth 414 and a fine teeth 416. Each of first gripping teeth 414 and fine teeth 416 indicates a gripping surface. As can be seen, first gripping teeth 414 have positioned at about a 90-degree angle, and fine teeth 416 present a flat surface. Further, first jaw 412 includes a first cutting portion 417 used to cut and strip wire. In the present embodiment, first handle 402 includes a pivot pin 418. Pivot pin 418 indicates a ridge or extending section extending from the surface of first extending section 410 facing second handle 420.

Second handle 420 presents a second gripping portion 422. Second gripping portion 422 has a non-slippery surface or ridged surface to facilitate gripping of second handle 420. Second gripping portion 422 includes a driver receiving section 426 configured to receive another drive member (not shown). Here, the drive member is connected by a screw 424. The presently disclosed embodiment is shown to illustrate two drive members that can be connected to front and rear handles (first and second handles).

Second handle 420 includes a second extending section 430. Second extending section 430 extends from second handle 420. Second extending section 430 extends at an angle of 20-45-degrees from second handle 420. Further, second extending section 430 includes a slot or aperture 432. Slot 432 has an elongated configuration and includes detents 434. Detents 434 indicate a series of curved steps or arcuate surfaces positioned at opposite sides of slot 432 that allow pivot pin 418 to guide along and lock at different positions. Here, detents 434 are positioned by pairs of opposite side curved steps or arcuate surfaces facing each other.

Second extending section 430 encompasses a second jaw 440. Second jaw 440 encompasses a second gripping teeth 442 and a fine teeth 444. Each of second gripping teeth 442 and fine teeth 444 indicates a gripping surface. As can be seen, second gripping teeth 442 have teeth each positioned at about 90-degree angle, and fine teeth 444 present a flat surface. Further, second jaw 440 includes a second cutting portion 446. Each of first cutting portion 417 and second cutting portion 446 presents a hardened/sharpened edge in the back of first jaw 412 and second jaw 440, respectively allowing gripping pliers 400 to be used to cut and strip wire. Here, the integrated wire cutting feature in the rear of jaws 410, 440 allows for gripping pliers 400 to be used as a pair of dikes (wire cutters). The dikes feature can also be used to strip electrical wire.

As explained above, pivot pin 418 is inserted in slot 432. First jaw 410 and second jaw 440 are angled relative to first handle 402 and second handle 420, such that first gripping teeth 414 and second gripping teeth 442 face each other in parallel when gripping pliers 400 is in closed configuration. The space or opening 70 formed between first gripping teeth 414 and second gripping teeth 442 permits holding/gripping of an object such as pipe, bolt, etc. Here, an opening 450 widens between first gripping teeth 414 and second gripping teeth 442 for gripping the object.

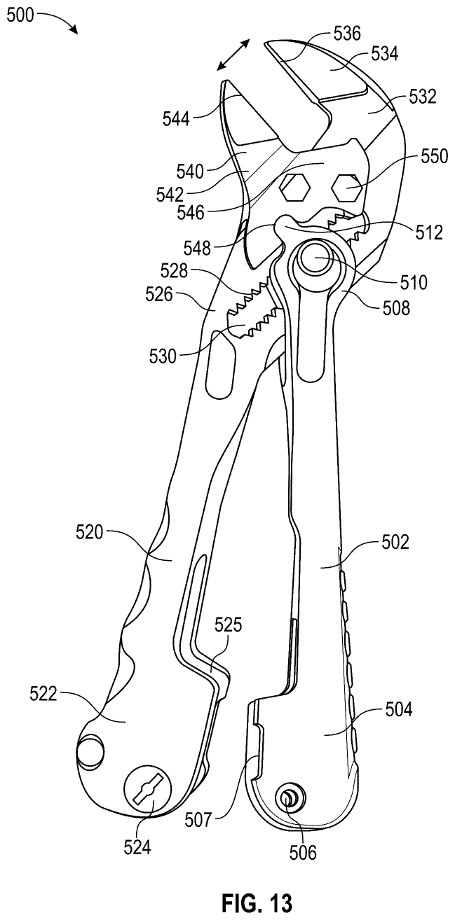

FIG. 13 shows a front view of gripping pliers 500, in accordance with another embodiment of the present invention. Gripping pliers 500 integrates a cam mechanism for jaw adjustment to grip objects. Gripping pliers 500 includes a pair of handles a first handle 502 and a second handle 520. First handle 502 includes a first gripping portion 504. First gripping portion 504 has a non-slippery surface or ridged surface to facilitate gripping of first handle 502. First handle 502 includes a drive slot 507. Drive slot 507 is positioned at the distal end of first handle 502 and receives a drive member (not shown) and/or knife member (not shown) via connecting member 506.

Further, first handle 502 includes a connecting portion 508. Connecting portion 508 is positioned at the opposite end of drive slot 507. Connecting portion 508 includes a pivot pin 510. Further, connecting portion 508 includes a cam lock 512. Cam lock 512 extends from the surface of connecting portion 508 and facilitates locking of first handle 502 relative to second handle 520.

Second handle 520 presents a second gripping portion 522. Second handle 520 includes a drive slot 525. Drive slot 525 is positioned at the distal end of second handle 520 and receives a drive member (not shown) and/or knife member (not shown) via connecting member 524.

Second handle 520 includes an extending section 526. Extending section 526 extends at an angle of 20-45 degrees from second handle 520. Extending section 526 includes a slot or aperture 530 with detents 528. Detents 528 indicate a series of curved or arcuate surfaces positioned at opposite sides of slot 530 that allow pivot pin 510 to guide along and lock at different positions. Here, detents 528 are positioned by pairs of opposite side curved steps or arcuate surfaces. Further, extending section 526 includes a first jaw 532. First jaw 532 presents a perpendicular section 535 having a first flat section 536. First flat section 536 grips flat-sided objects such as nuts and hex bolts.

Further, gripping pliers 500 includes a second jaw 540. Second jaw 540 removably connects to first handle 502 and interfaces with first flat section 536. Second jaw 540 includes a curved section 542 and a second flat section 544. Second flat section 544 interfaces with first flat section 536 and grips flat-sided objects such as nuts and hex bolts. In some implementations, second jaw 540 includes a connecting section 546 that goes over extending section 526 and enables second jaw 540 to connect to second handle 520. Connecting section 546 includes a cam groove 548. Cam groove 548 operatively receives cam lock 512 and adjusts second jaw 540 to increase or decrease the distance between first flat section 536 and second flat section 544. It should be understood that first jaw 532 acts as a fixed jaw and second jaw 540 acts as a movable jaw by the operation of pivot pin 510 in slot 530 and locking of cam lock 512 at cam groove 548. In some cases, connecting section 546 has grooves 550 positioned in hexagonal or any other configuration.

The integration of pivot pin 512 within slot 530, and cam mechanism formed by cam lock 512 and cam groove 548, allows for adjustment of jaw opening between first flat section 536 and second flat section 544 and locking of second jaw 540 relative to first jaw 530.

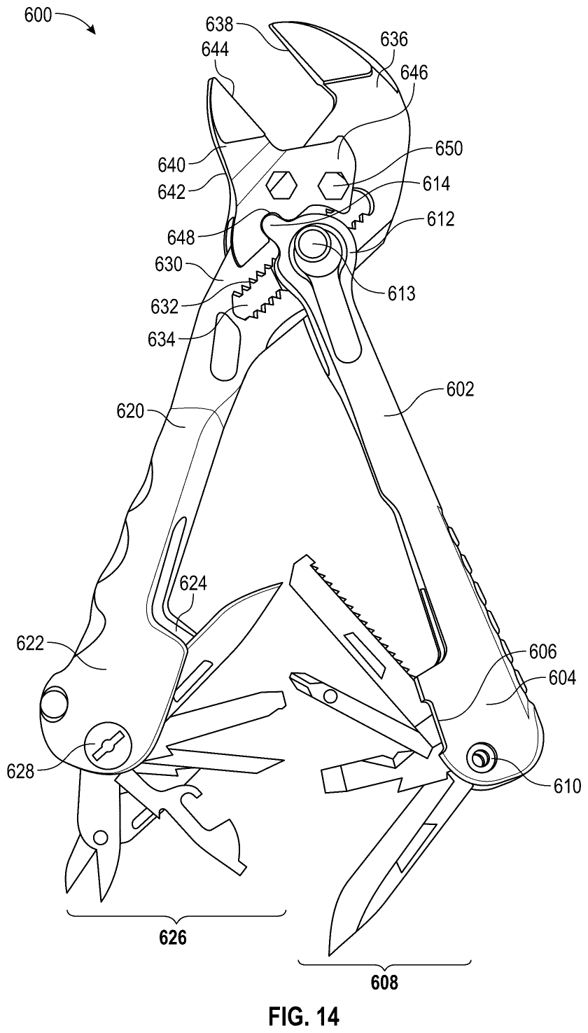

FIG. 14 shows a front view of gripping pliers 600, in accordance with another embodiment of the present invention. Gripping pliers 600 integrates a cam mechanism for jaw adjustment to grip objects, and a plurality of drive members, similar to a Swiss Knife. Gripping pliers 600 includes a pair of handles a first handle 602 and a second handle 620. First handle 602 includes a first gripping portion 604. First gripping portion 604 has a non-slippery surface or ridged surface to facilitate gripping of first handle 602. First handle 602 includes a drive slot 606. Drive slot 606 is positioned at the distal end of first handle 602 and receives a plurality of first drive members 608 via connecting member 610. Plurality of first drive members 608 includes a knife, screw driver, blade, chipping tool, etc.

Further, first handle 602 includes a connecting portion 612. Connecting portion 612 is positioned at the opposite end of drive slot 606. Connecting portion 612 includes a pivot pin 613. Further, connecting portion 612 includes a cam lock 614. Cam lock 614 extends from the surface of connecting portion 612 and facilitates locking of first handle 602 relative to second handle 620.

Second handle 620 presents a second gripping portion 622. Second handle 620 includes a drive slot 624. Drive slot 624 is positioned at the distal end of second handle 620 and receives a plurality of second drive members 626 via a connecting member 628. Plurality of second drive members 626 includes a knife, screw driver, blade, chipping tool, etc.

Second handle 620 includes an extending section 630. Extending section 630 extends at an angle of 20-45 degrees from second handle 620. Extending section 630 includes a slot or aperture 634 with detents 632. Detents 632 indicate a series of curved or arcuate surfaces positioned at opposite sides of slot 634 that allow pivot pin 613 to guide along and lock at different positions. Here, detents 632 are positioned by pairs of opposite side curved steps or arcuate surfaces. Further, extending section 630 includes a first jaw 636. First jaw 636 presents a first flat section 638. First flat section 638 grips flat-sided objects such as nuts and hex bolts.

Further, gripping pliers 600 includes a second jaw 640. Second jaw 640 removably connects to first handle 602 and interfaces with first flat section 638. Second jaw 640 includes a curved section 642 and a second flat section 644. Second flat section 644 interfaces with first flat section 638 and grips flat-sided objects such as nuts and hex bolts. In some implementations, second jaw 640 includes a connecting section 646 that goes over extending section 630 and enables second jaw 640 to connect to second handle 620. Connecting section 646 includes a cam groove 648. Cam groove 648 operatively receives cam lock 614 and adjusts second jaw 640 to increase or decrease the distance between first flat section 638 and second flat section 644. It should be understood that first jaw 636 acts as a fixed jaw and second jaw 640 acts as a movable jaw by the operation of pivot pin 613 in slot 634 and locking of cam lock 614 at cam groove 648. In some cases, connecting section 646 has grooves 650 positioned in hexagonal or any other configuration.

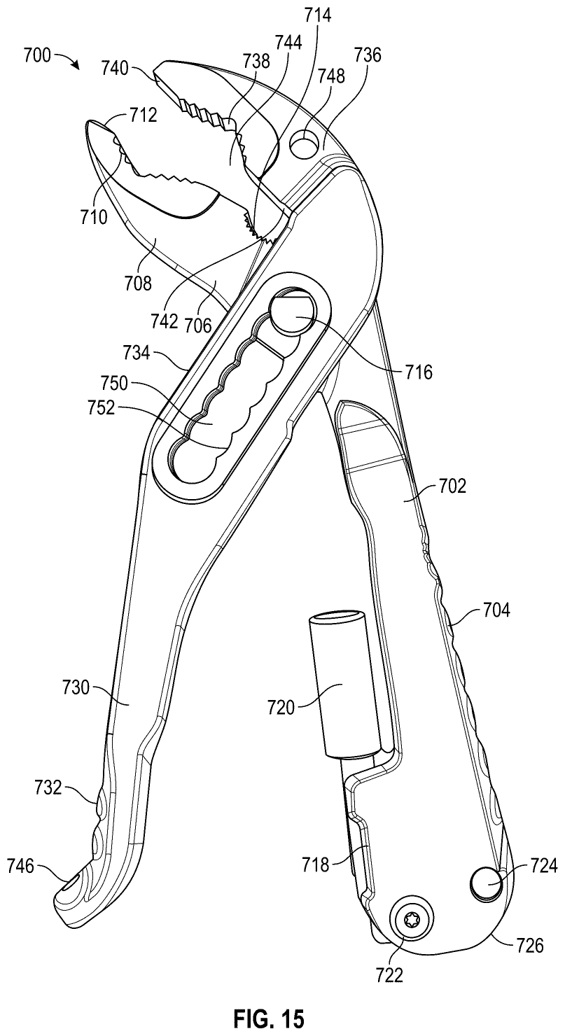

FIG. 15 shows a side view of gripping pliers 700 in an open configuration, in accordance with one embodiment of the present invention. Gripping pliers 700 includes a pair of handles, say a first handle 702 and a second handle 730. In one implementation, first handle 702 indicates a bottom handle and second handle 730 indicates a top handle, or vice versa. First handle 702 positions underneath second handle 730. First handle 702 presents a first gripping portion 704. First gripping portion 704 includes a non-slippery surface or receives a grip for firm grip. First handle 702 includes a first extending section 706 extending from first handle 702. As can be seen, first extending section 706 extends at an angle from first handle 702. In one example, first handle 702 and first extending section 706 come as a single component. Here, first extending section 706 extends between 20-45-degree angle from first handle 702. Further, first extending section 706 encompasses a first jaw 708. First jaw 708 presents a first gripping teeth 710 and a fine teeth 712. Each of first gripping teeth 710 and fine teeth 712 indicates a gripping surface. As can be seen, first gripping teeth 710 have teeth at about 90-degree angle, and fine teeth 712 presents a flat surface. Further, first jaw 708 presents a first cutting portion 714. First cutting portion 714 comes in a semi-circular configuration has comprises teeth.

In the present embodiment, first handle 702 includes a pivot pin 716 (similar to pivot pin 32 shown in FIG. 2). Pivot pin 716 indicates a ridge or extending section extending from the surface of first extending section 706 facing second handle 730.

Gripping pliers 700 includes a driver receiving section 718 at the bottom i.e., at the end of first gripping portion 704. Driver receiving section 718 defines an area configured to receive a driver member 720 in its closed configuration. Driver member 720 indicates a bit driver. In one example, drive member 720 removably connects to gripping pliers 700 via a connecting member 722, such as a fastener. Here, drive member 720 hingedly connects to gripping pliers 700 such that drive member 720 folds and sits adjacent to first handle 702. Further, drive member 720 extends from first handle 702 in an open configuration or engaged configuration.

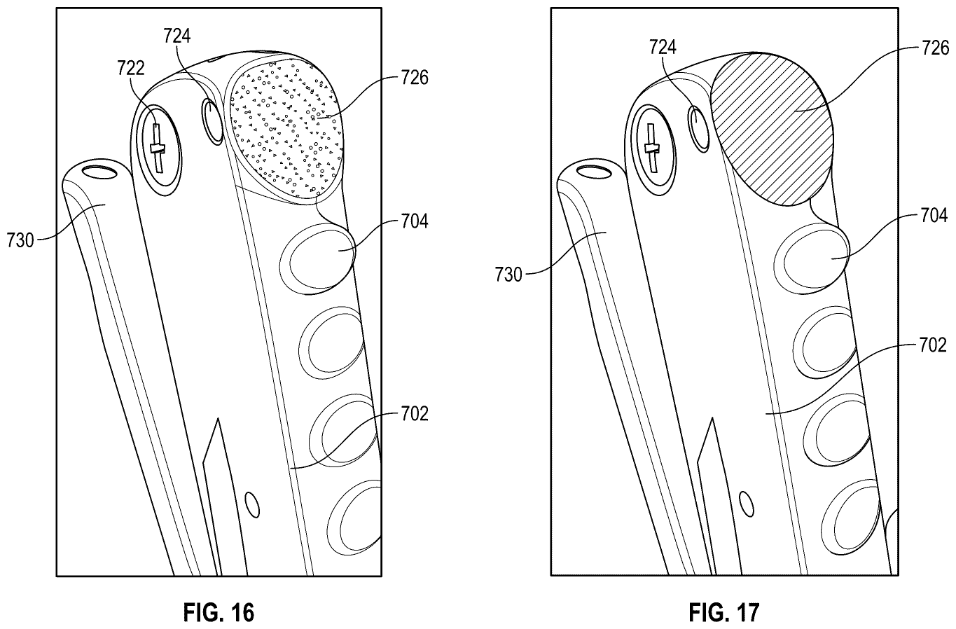

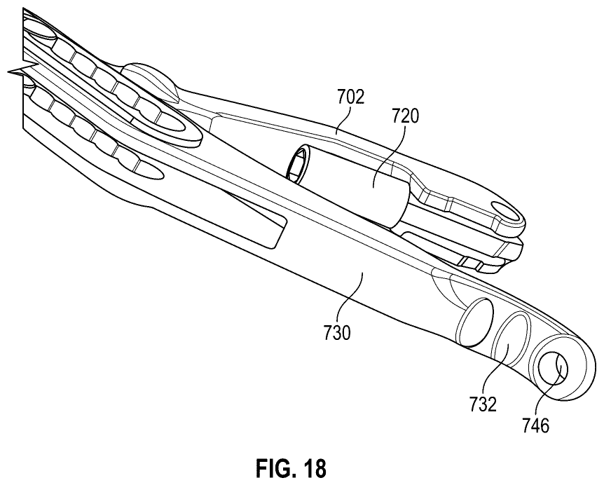

In the present embodiment, first handle 702 includes a first hole 724 positioned at the proximity to its distal end. First hole 724 configures to draw a wire and bend. Further, first handle 702 incorporates a hammer region 726. Hammer region 726 is positioned at the outer side of first handle 702 at its bottom. FIG. 16 and FIG. 17 show different configurations (rough and smooth surface) of hammer region 726 on first handle 702. Hammer region 726 is positioned at the back of first handle 702, such that hammer region 726 can be used to hit on a fastener or other objects, during its use. Hammer region 726 may have a striking surface area with a textured pattern or flush/plain surface to prevent slippage during impact operations. Hammer region 726 may be heat-treated to HRC 45-50 to provide durability while maintaining sufficient toughness to prevent chipping or cracking under repeated impact loads

Referring back to FIG. 15, gripping pliers 12 includes second handle 730. Second handle 730 presents a second gripping portion 732. Second handle 730 includes a second extending section 734 extending from second handle 730. As can be seen, second extending section 734 extends at an angle from second handle 730. In one example, second extending section 734 extends between 20-45-degree angle from second handle 730. Further, second extending section 734 encompasses a second jaw 736. Second jaw 736 encompasses a second gripping teeth 738 and a fine teeth 740. Each of second gripping teeth 738 and fine teeth 740 indicates a gripping surface. As can be seen, second gripping teeth 738 have teeth positioned at about 90-degree angle, and fine teeth 740 presents a flat surface.

Further, second jaw 736 presents a second cutting portion 742. Each of first cutting portion 710 and second cutting portion 742 presents a hardened/sharpened edge in the back of first jaw 708 and second jaw 736, respectively allowing gripping pliers 700 to be used to cut and strip wire. Here, the integrated wire cutting feature in the rear of jaws 708, 736 allows for gripping pliers 700 to be used as a pair of dikes (wire cutters). The dikes feature can also be used to strip electrical wire. Similarly, an object can be held or cut using first cutting portion 714 and second cutting portion 742. Further, space or opening 70 is formed between first gripping teeth 710 and second gripping teeth 738 to hold/grip an object such as pipe, bolt, etc.

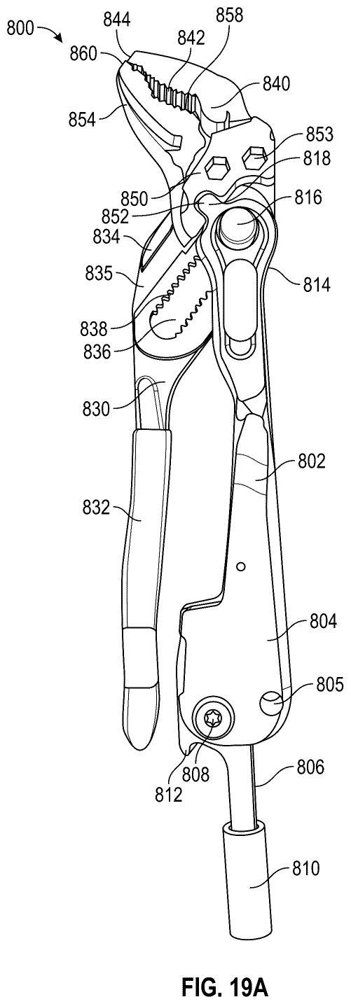

In the present embodiment, second handle 730 encompasses a second hole 746 at its distal end i.e., closer to second gripping portion 732. FIG. 18 shows the feature of second handle 730 having second hole 746. Here, second hole 746 is used for bending a wire (not shown). In some embodiments, second jaw 736 has a third hole 748 at the top. Third hole 748 is used for bending a wire (not shown). Each of first hole 724, second hole 746 and third hole 748 may have diameters ranging from 3-8 mm to accommodate various wire gauges from 12 AWG to 22 AWG. The holes may be chamfered at 45-degree angles to prevent wire damage during bending operations and may be positioned to provide bending radii compliant with electrical code requirements.

Further, second extending section 734 includes a slot or aperture 750. Slot 750 has an elongated configuration and includes detents 752. Detents 752 indicate a series of curved steps or arcuate surfaces positioned at opposite sides of slot 750 that allow pivot pin 716 to guide along and lock at different positions. Here, detents 752 are positioned by pairs of opposite side curved steps or arcuate surfaces facing each other.

The presently disclosed gripping pliers 700 operates similar to gripping pliers 12, described above.

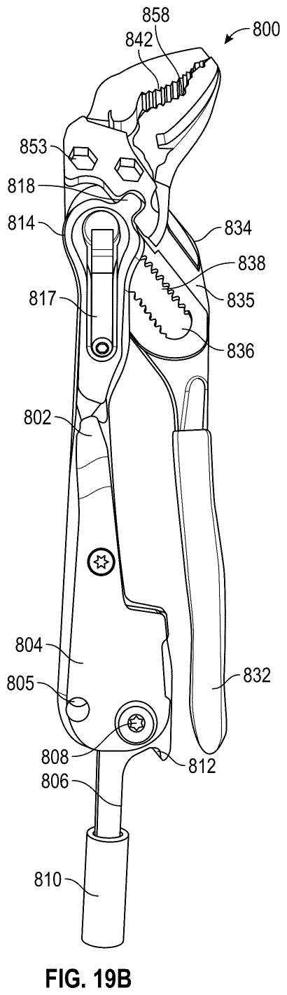

FIG. 19A and FIG. 19B show a front view and a rear view, respectively of gripping pliers 800, in accordance with another embodiment of the present invention. Gripping pliers 800 integrates a cam mechanism for jaw adjustment to grip objects. Gripping pliers 800 includes a pair of handles i.e., a first handle 802 and a second handle 830. First handle 802 includes a first gripping portion 804. First gripping portion 804 has a non-slippery surface or ridged surface to facilitate gripping of first handle 802. First handle 802 includes a first hole 805. First hole 805 is used for drawing and bending a wire (not shown).

First handle 802 includes an extending rod 806 that swivels and folds into first handle 802. Extending rod 806 connects via a connector 808. Connector 808 is positioned at the distal end of first handle 802 and receives extending rod 806. In some embodiments, extending rod 806 includes a drive member 810. Drive member 810 may be replaced by different tools such as saws, files, etc. Further, first handle 802 encompasses a tab member 812 that functions as a bottle opener.

Further, first handle 802 includes a connecting portion 814. Connecting portion 814 is positioned at the opposite end of connector 808. Connecting portion 814 includes a pivot pin 816. Connecting portion 814 is tightened using a lever 817, as shown in FIG. 19B. Further, connecting portion 814 includes a cam lock 818. Cam lock 818 extends from the surface of connecting portion 814 and facilitates locking of first handle 802 relative to second handle 830.

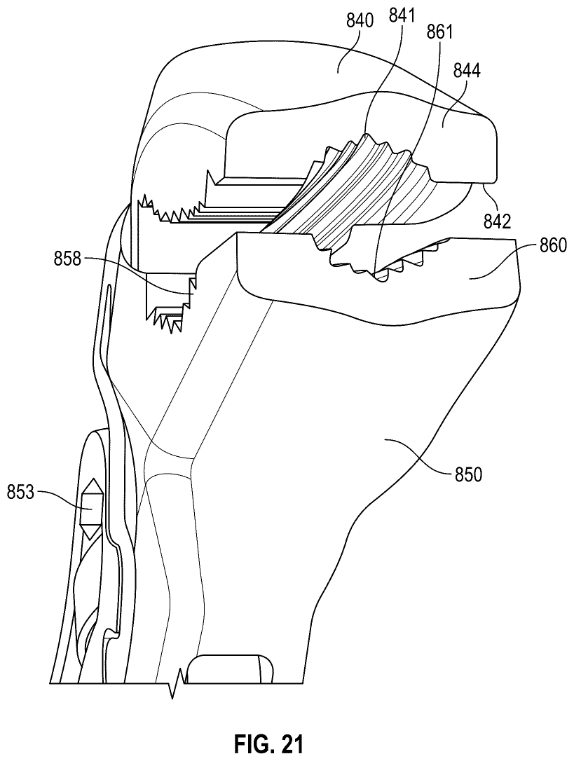

Second handle 830 includes a second gripping portion 832. Second handle 830 includes an extending section 834. As can be seen, extending section 834 extends at an angle from second handle 830. In one example, extending section 834 extends at an angle of 20-45 degrees from second handle 830. Extending section 834 includes a sliding groove 835 that allows connecting section 250 to slide. Extending section 834 includes a slot or aperture 836. Slot 836 has an elongated configuration and includes detents 238. Detents 838 indicate a series of curved or arcuate surfaces positioned at opposite sides of slot 836 that allow pivot pin 816 to guide along and lock at different positions. Here, detents 838 are positioned by pairs of opposite side curved steps or arcuate surfaces. Further, extending section 834 includes a first jaw 840. First jaw 840 extends perpendicularly from extending section 834. First jaw 840 encompasses a first teeth 842 and second teeth 841. FIG. 21 shows second teeth 841 formed in an arc shaped configuration to grip objects. First jaw 840 has a first end section 844 that is provided in a flat configuration.

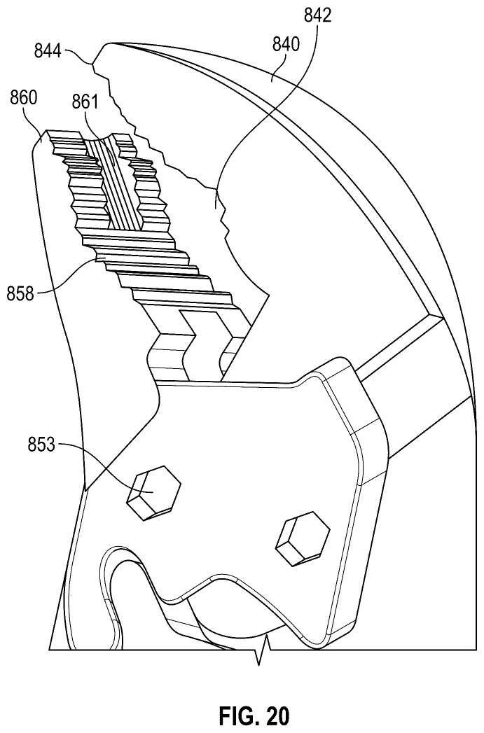

Further, gripping pliers 800 includes a connecting section 850. Connecting section 850 removably connects to first handle 802, and includes a cam groove 852. In some cases, connecting section 850 has grooves 853 positioned in hexagonal or any other configuration. Connecting section 850 includes a second jaw 854. Second jaw 854 includes a third teeth 858 and fourth teeth 861 (FIG. 20). Second teeth 841 and fourth teeth 861 may have teeth perpendicularly to first teeth 842 and third teeth 858. As can be seen, second teeth 841 and fourth teeth 861 are arc-shaped allowing rounded or irregular shaped or damaged nuts to be held with them.

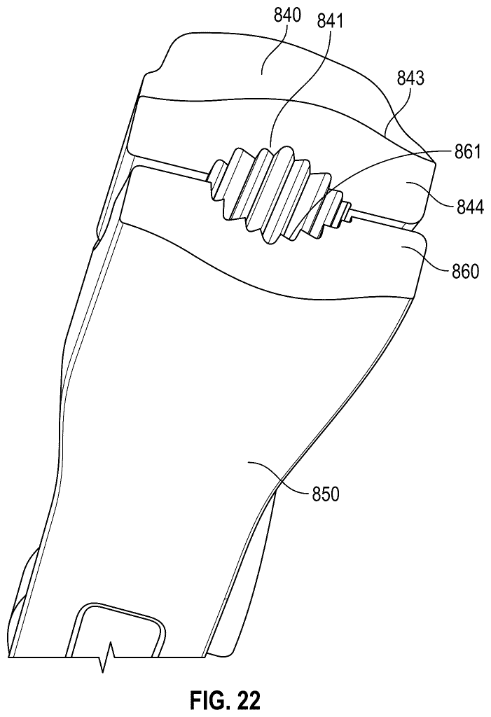

Second jaw 854 has a second end section 860 that is provided in a flat configuration. FIG. 21 and FIG. 22 show the feature of first jaw 840 and second jaw 854 in open configuration and closed configuration, respectively. As can be seen, first end section 844 and second end section 860 are made to position parallelly when opening and closing. This allows first jaw 840 and second jaw 854 to grip nuts, bolts, and other rounded or damaged fasteners. Gripping pliers 800 offer parallel jaw action combined with heavy duty gripping teeth. A person skilled in the art understands that gripping pliers 800 to include multiple attachment points or accessories as shown in FIG. 14 to enhance its functionality and use in a variety of applications.

The presently disclosed gripping pliers can be used in a variety of applications. For instance, the gripping pliers can provide multifunctional capabilities for plumbing operations. The jaws can be used to grip pipes, fittings, and valves during installation and repair work. The adjustable jaw mechanism allows the gripping pliers to accommodate different pipe sizes from small copper tubes to large PVC pipes. The gripping teeth engage nuts and bolts on pipe connections. The cutting portions can be used to strip and cut electrical wires in plumbing systems. The driver member can be used to drive screws on pipe brackets and mounting hardware. In some cases, the gripping pliers having include wire bending holes can be used to bend copper tubing for water supply lines.

Further, the gripping pliers can be used in HVAC applications e.g., for refrigeration lines and ductwork connections. The jaws can hold round and square ductwork while workers secure joints. The driver member installs screws on vent covers and air handlers. The cutting portions strip thermostat wires and control cables. Further, wire bending holes can bend copper tubing for refrigerant lines. In some implementations, the hammer region can be used to provide impact capability for ductwork alignment.

The gripping pliers can facilitate electrical installation and maintenance operations. For example, The jaws can be used to grip conduit fittings and electrical boxes during installation. The gripping teeth can be used to hold wire nuts while workers make connections. The cutting portions can be used to strip insulation from electrical cables. The driver member can be used to install outlet covers and switch plates. In some cases, the gripping pliers having a knife member can be used to cut cable sheathing and insulation materials.

Similarly, the gripping pliers can provide automotive repair capabilities for fuel lines, brake lines, and coolant hoses. Additionally, the gripping pliers can accommodate industrial maintenance requirements for machinery and equipment. Further, the gripping pliers can facilitate oil and gas field operations for wellheads and pipelines. Furthermore, the gripping pliers can provide construction capabilities for rebar ties and wire mesh during concrete work.

The presently disclosed gripping pliers provides several advantages over the prior art. The gripping pliers combines three tools such as water pump pliers, a wire cutter, and a bit driver and offers a single multifunctional gripping plier. This reduces the need for multiple tools and increases efficiency. The self-locking jaws has a large jaw capacity of up to 1.25″ and that makes it suitable for industrial applications, when compared with traditional multitools with limited jaw capacities. The gripping pliers with handles allow the user to access objects such as pipes in confined spaces whilst retaining maximum leverage. Further, the gripping pliers have wire cutting features eliminating the need for a separate wire cutter. Furthermore, the foldable magnetic bit driver allows the gripping pliers to be used as a screwdriver. Additionally, the first handle integrates a foldable knife member that positions adjacent to the drive member. The knife member allows the gripping pliers to be used as a knife for cutting or slicing objects. The foldable bit driver and the knife member make the gripping pliers appear like a Swiss army knife. The gripping pliers offers multiple functions in a single tool thereby saving space and improving productivity in plumbing, HVAC, oil/gas, and industrial maintenance applications.

A person skilled in the art appreciates that the gripping pliers can come in a variety of shapes and sizes depending on the need and comfort of the user. Further, many changes in the design and placement of components may take place without deviating from the scope of the presently disclosed gripping pliers.

In the above description, numerous specific details are set forth such as examples of some embodiments, specific components, devices, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A multifunctional gripping pliers, comprising:
a first handle comprising a first extending section, wherein said first extending section comprises a first jaw having first gripping teeth;
a second handle comprising a second extending section, wherein said second extending section comprises a second jaw having second gripping teeth;
a foldable tool hingedly connected to one of said first handle and said second handle;
a slot extending through said second extending section, wherein said slot comprises detents positioned at opposite sides within said slot; and
a pivot pin extending from said first extending section and insertable into said slot,
wherein said first gripping teeth and said second gripping teeth face each other to form an opening for gripping an object therebetween, and wherein said pivot pin locks in said detents to secure said first jaw and said second jaw in position.

2. The multifunctional gripping pliers of claim 1, wherein said foldable tool is a bit driver configured to receive ¼ inch bits.

3. The multifunctional gripping pliers of claim 1, wherein each of said first jaw and said second jaw comprises fine teeth positioned adjacent to said first gripping teeth and said second gripping teeth respectively, and wherein said fine teeth present a flat gripping surface.

4. The multifunctional gripping pliers of claim 1, further comprises a first cutting portion positioned at said first jaw and a second cutting portion positioned at said second jaw, wherein said first cutting portion and said second cutting portion are configured to cut and strip wire.

5. The multifunctional gripping pliers of claim 4, wherein each of said first cutting portion and said second cutting portion comprises a hardened cutting edge.

6. The multifunctional gripping pliers of claim 1, wherein said foldable tool is a knife member.

7. The multifunctional gripping pliers of claim 1, said foldable tool comprises a drive member and a knife member positioned adjacent to each other, wherein each of said drive member and said knife member hingedly connects to said first handle or said second handle.

8. The multifunctional gripping pliers of claim 1, wherein said foldable tool holder integrates a magnetic member configured to retain said foldable tool in a folded position against said first handle or said second handle.

9. The multifunctional gripping pliers of claim 1, wherein said pivot pin comprises a cutout section and an arcuate section, and wherein said cutout section is configured to engage with said detents and said arcuate section for movement within said slot.

10. The multifunctional gripping pliers of claim 1, wherein said first handle comprises a hammer region integrated at its outer side.

11. The multifunctional gripping pliers of claim 1, wherein at least one of said first handle, said second handle, and said second jaw comprises a hole configured for drawing and bending a wire.

12. The multifunctional gripping pliers of claim 1, wherein said first jaw comprises a first end section having a flat configuration and said second jaw comprises a second end section having a flat configuration, and wherein said first end section and said second end section are positioned to face each other in parallel alignment for gripping rounded or irregular shaped objects therebetween.

13. A multifunctional gripping pliers, comprising:
a first handle comprising a first jaw with first gripping teeth;
a second handle;
a movable jaw removably attached to said second handle, wherein said movable jaw comprises a second gripping teeth, wherein said first gripping teeth and said second gripping teeth face each other to form an opening for gripping an object therebetween;
a pivot mechanism connecting said first handle and said second handle, wherein said pivot mechanism comprises a pivot pin extending from said first handle and a slot with detents in said second handle, wherein said pivot pin is insertable into slot to allow adjustment of said opening between said first gripping teeth and said second gripping teeth;
a cam mechanism comprising a cam lock positioned at said first handle and a cam groove provided at said movable jaw, wherein said cam lock engages said cam groove to lock said movable jaw relative to said first jaw for gripping said object; and
a foldable tool hingedly connected to one of said first handle and said second handle, wherein said foldable tool is configured to fold into one of said first handle and said second handle, when not in use.

14. The multifunctional gripping pliers of claim 13, wherein said foldable tool is a bit driver configured to receive ¼ inch bits.

15. The multifunctional gripping pliers of claim 13, wherein said foldable tool is a knife member.

16. The multifunctional gripping pliers of claim 13, wherein said movable jaw further comprises hexagonal grooves configured to engage hex nuts and bolts.

17. The multifunctional gripping pliers of claim 13, wherein each of said first jaw and said movable jaw comprises a cutting portion for cutting and stripping wire.

18. The multifunctional gripping pliers of claim 13, wherein said first handle comprises a hammer region at its outer side.

19. The multifunctional gripping pliers of claim 13, wherein at least one of said first handle, said second handle, and said second jaw comprises a hole configured for drawing and bending a wire.

20. A method of providing a multifunctional gripping pliers, said method comprising the steps of:
providing a first handle comprising a first extending section, said first extending section comprising a first jaw having first gripping teeth;
providing a second handle comprising a second extending section, said second extending section comprising a second jaw having second gripping teeth;
providing a foldable tool hingedly connected to one of said first handle and said second handle;
providing a slot extending through said second extending section, said slot comprising detents positioned at opposite sides within said slot;
providing a pivot pin extending from said first extending section and insertable into said slot; and
forming an opening by making said first gripping teeth and said second gripping teeth face each other for gripping an object therebetween, and said pivot pin locking in said detents for securing said first jaw and said second jaw in position.
